(19) United States
(12) Patent Application Publication
(10) Pub. No.: US 2020/0006784 A1
(43) Pub. Date: Jan. 2, 2020

(54) GRADUATED CONDUCTIVE FILMS AND ENERGY HARVESTERS

(71) Applicant: Board of Regents, The University of Texas System, Austin, TX (US)

(72) Inventors: Guihua Yu, Austin, TX (US); Fei Zhao, Austin, TX (US); Xingyi Zhou, Austin, TX (US); Ye Shi, Austin, TX (US)

(21) Appl. No.: 16/401,815

(22) Filed: May 2, 2019

Related U.S. Application Data
(60) Provisional application No. 62/665,802, filed on May 2, 2018.
(60) Provisional application No. 62/665,796, filed on May 2, 2018.

(51) Int. Cl. H01M 6/34; H01M 6/02

(52) U.S. Cl. CPC H01M 6/34; H01M 6/02

(57) ABSTRACT

Disclosed herein are novel conductive films exhibiting graduated electrical resistance. The films can be prepared by asymmetrically oxidizing conductive film, thereby increasing electrical resistance along a gradient. The films can advantageously be employed in salt-water energy harvesters.

### CROSS-REFERENCE TO RELATED APPLICATION

This application claims the benefit of U.S. Provisional Applications 62/665,796, filed May 2, 2018, and 62/665,802, filed May 2, 2018, the contents of each are hereby incorporated in their entirety.

### FIELD OF THE INVENTION

The invention is directed to conductive films exhibiting conductivity gradients, methods of making such films, and method of using such films. The films may be used in energy harvesters to generate electricity.

### BACKGROUND

Gradient structures of materials can be defined broadly as molecular or macromolecular patterns with a spatiotemporal change of at least one of their physicochemical characteristic, that changes gradually over a certain length in space and may even evolve in time. Materials with gradient properties can be used for development of various novel devices, such as highly sensitive sensors, bio-surfaces for protein adsorption and cell adhesion, and energy conversion applications. Within different gradient properties, the conductivity gradient is of particular interest owing to its diverse applications. However, the pioneering works are all based on deposition or desorption of organic/polymeric molecules or inorganic materials involved at the surface of a conducting substrate and a material platform which can reach a conductivity difference over degree of five orders within the gradient is still lacking.

Conductive polymers are materials with highly π-conjugated polymer chains and they have received considerable research interests from both academia and industry owing to their ability to offer tunable electrical conductivity while maintaining properties associated with conventional polymers, such as ease of synthesis and flexibility in processing. Different from conventional inorganic materials, the conductivity of conductive polymers can be facilely tuned within a large range since it is associated with the molecular structures of materials, the level of doping, as well as the ordering of molecular packing. Thus, conductive polymers are promising candidates for fabrication of thin films with significant conductivity gradient.

### SUMMARY

Disclosed herein are novel conductive films exhibiting graduated electrical resistance. The films can be prepared by asymmetrically oxidizing conductive film, thereby increasing electrical resistance along a gradient.

The details of one or more embodiments are set forth in the descriptions below. Other features, objects, and advantages will be apparent from the description and from the claims.

### BRIEF DESCRIPTION OF THE FIGURES

FIG. 1 includes a depiction of conductivity enhancement via secondary doping.

FIG. 2 includes a depiction of bipolar treatment of a conductive film, and a depiction of a 1-D bipolar cell device.

FIG. 3 includes depictions of a film with graduated electrical resistance. (a) measure positions on the film; (b) effective of treatment time; (c) effect of applied current; (d) effect of film thickness.

FIG. 4 includes a depiction of electrode height impact on resistance gradient in a 1-D device.

FIG. 5 includes a depiction of electrode distance impact on resistance gradient in a 1-D device.

FIG. 6 includes a depiction of a gradient film produced using a 1-D device characterized by (a) FTIR spectroscopy; (b) Raman spectroscopy; and (c) atomic force microscopy.

FIG. 7 includes a depiction of a 2-D bipolar cell device.

FIG. 8 includes a depiction of electrode size on resistance gradient in a 2-D device.

FIG. 9 includes a depiction of electrode height on resistance gradient in a 2-D device.

FIG. 10 includes a depiction of a 2-D bipolar cell device.

FIG. 11 includes several depictions of an energy harvesting device.

FIG. 12 depicts the effect of the gradient on voltage generation: (a) 10² gradient; (b) 10³ gradient; (c) 10⁴ gradient; (d) 10⁴ gradient.

FIG. 13 depicts the effect of the gradient on current generation: (a) 10² gradient; (b) 10³ gradient; (c) 10⁴ gradient; (d) 10⁴ gradient.

FIG. 14 depicts the effect of the ion concentration on voltage generation: (a) 1 mg/ml; (b) 10 mg/ml; (c) 35 mg/ml; (d) 100 mg/ml.

FIG. 15 depicts the effect of the ion concentration on current generation: (a) 1 mg/ml; (b) 10 mg/ml; (c) 35 mg/ml; (d) 100 mg/ml.

FIG. 16 depicts the effect of the flow rate on voltage generation: (a) 0.9 ml/s; (b) 1.3 ml/s; (c) 2.2 ml/s; (d) 2.9 ml/s.

FIG. 17 depicts the effect of the flow rate on current generation: (a) 0.9 ml/s; (b) 1.3 ml/s; (c) 2.2 ml/s; (d) 2.9 ml/s.

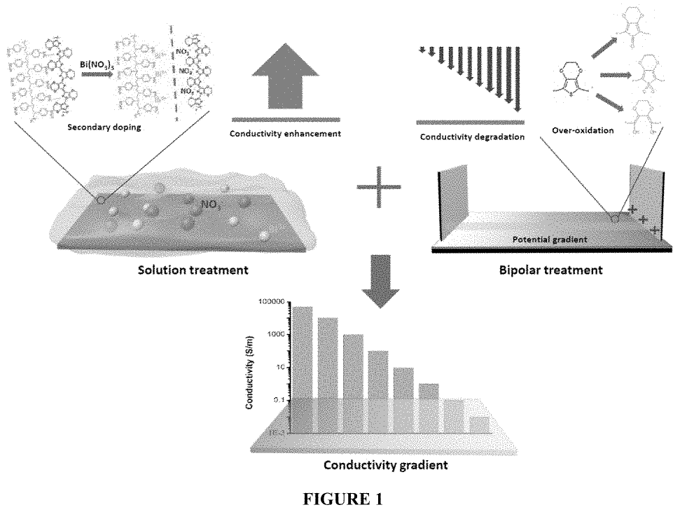

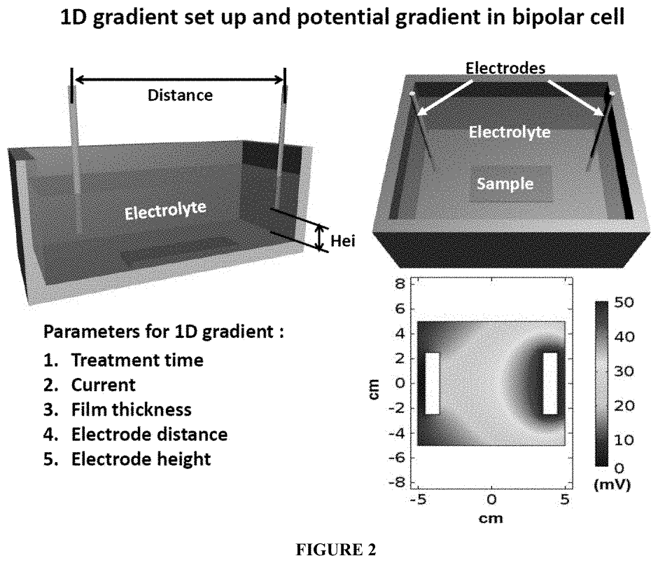

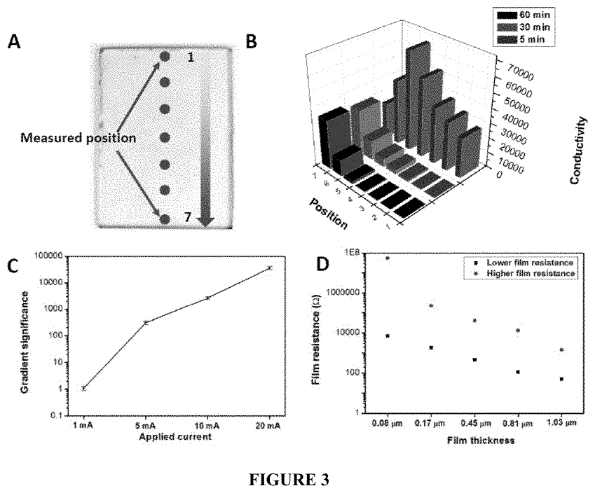

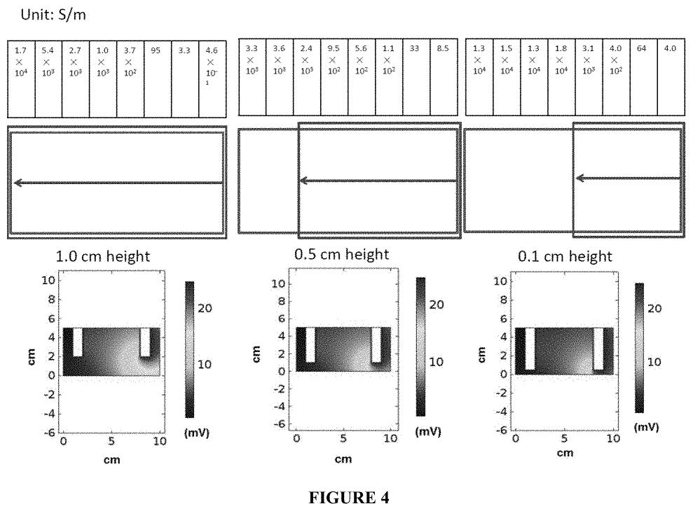

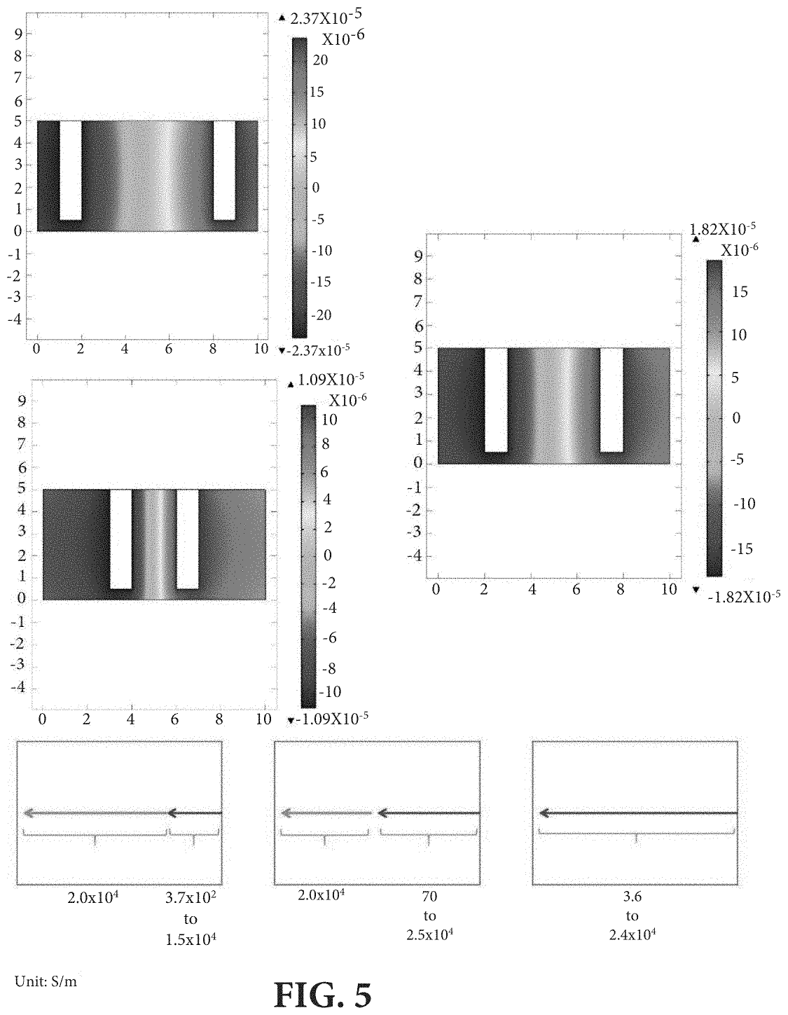

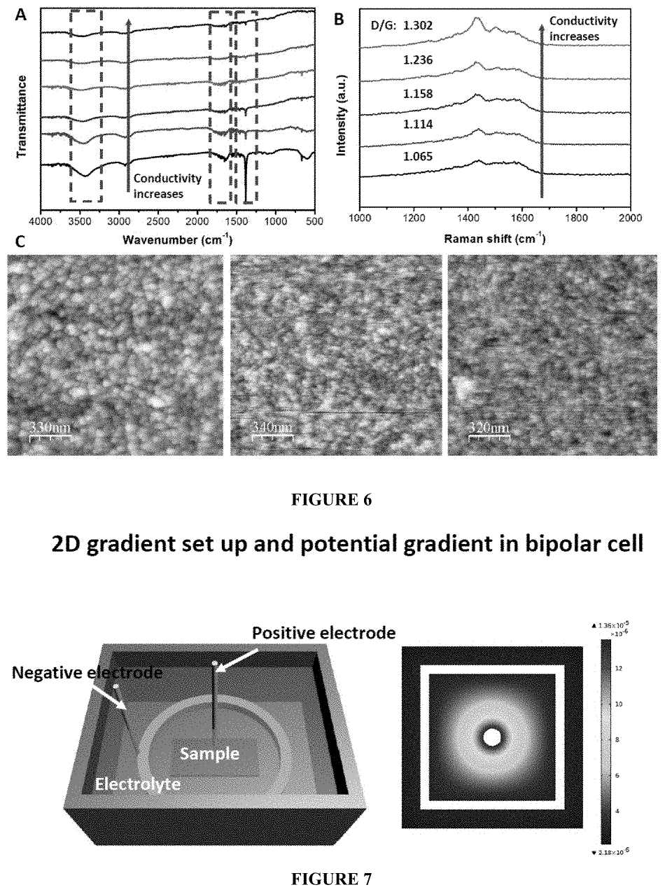

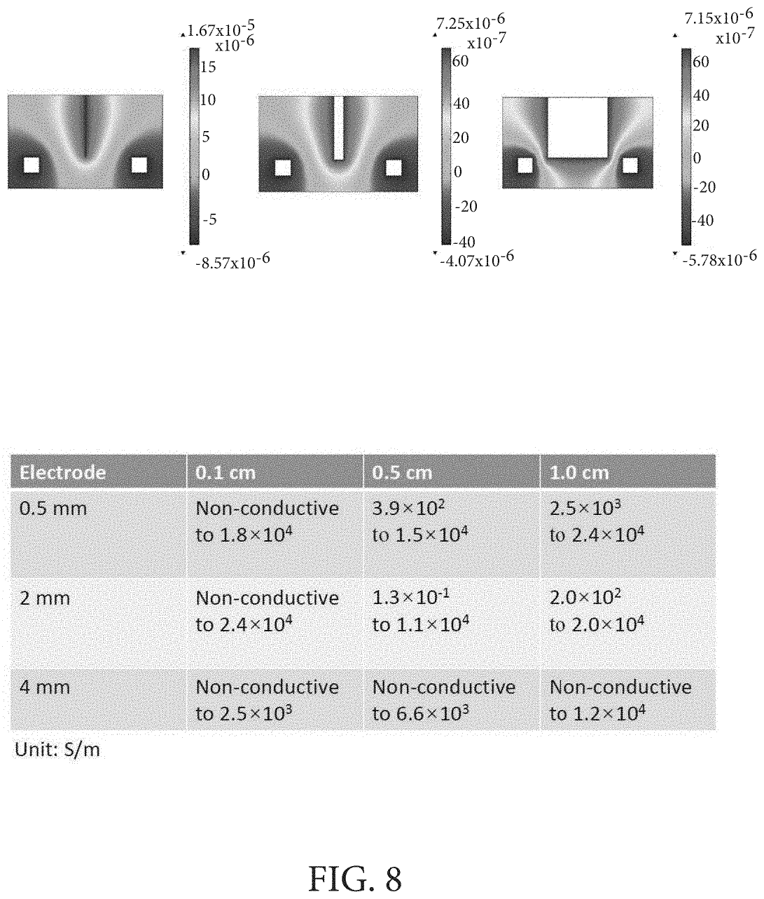

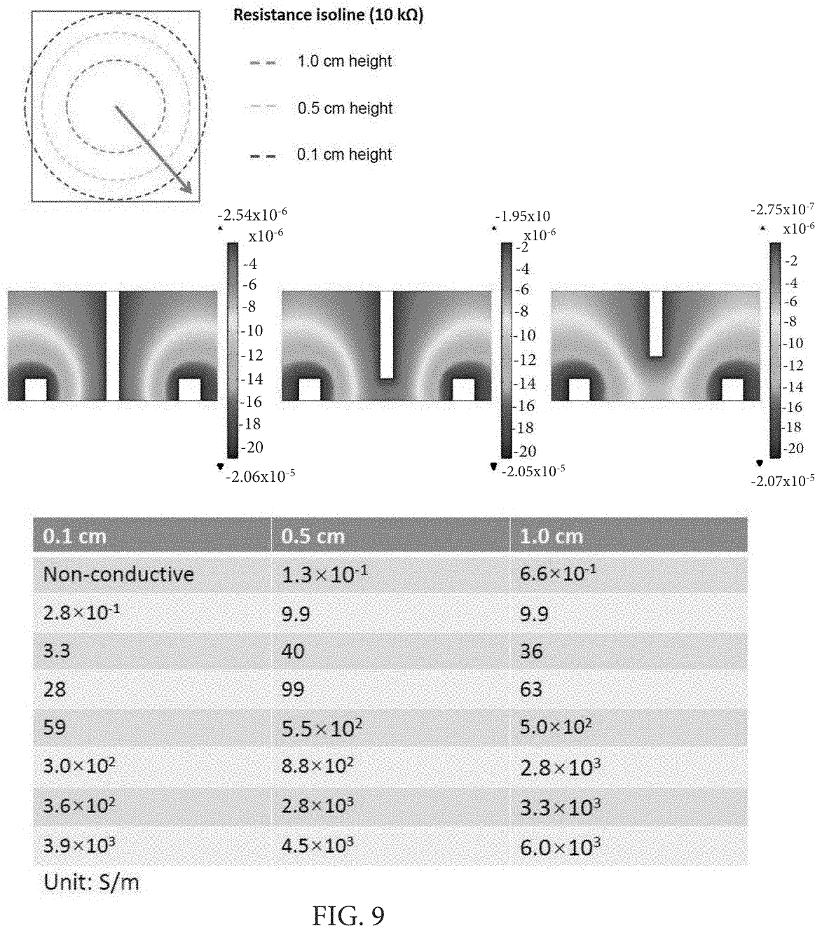

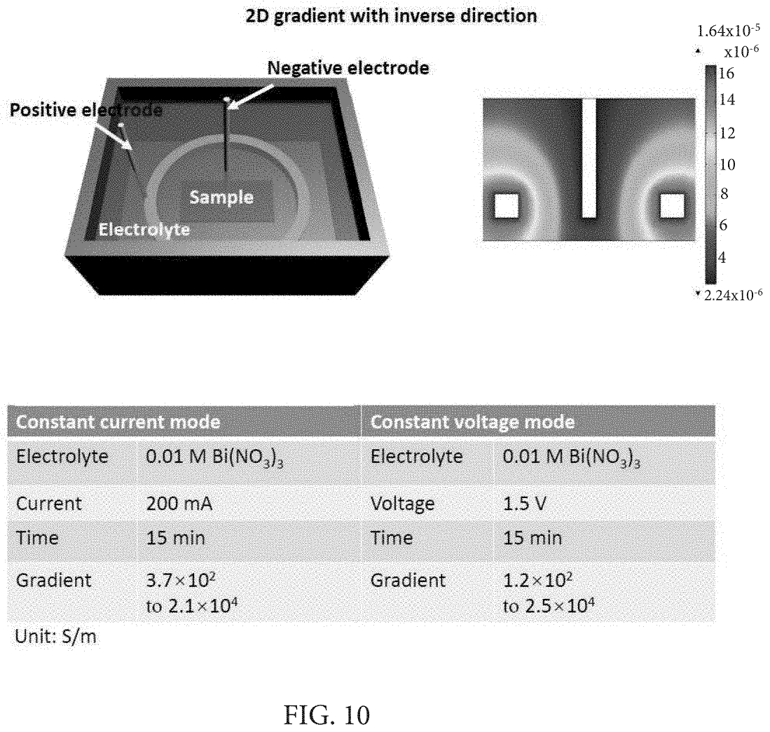

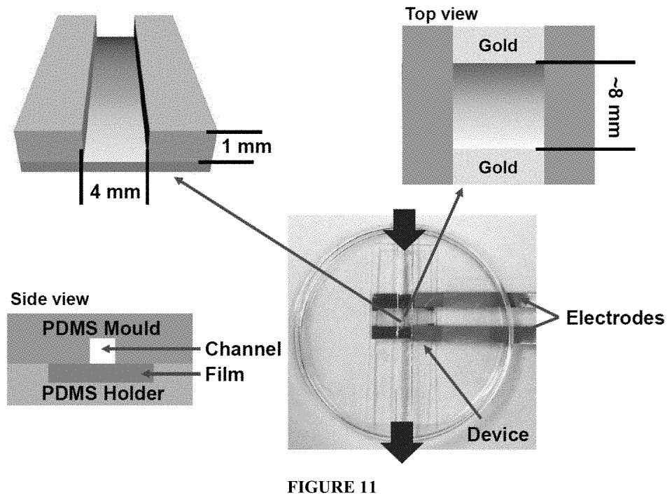

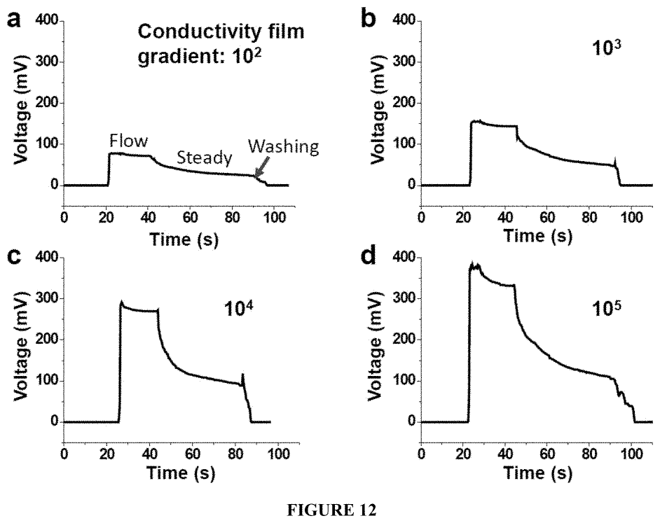

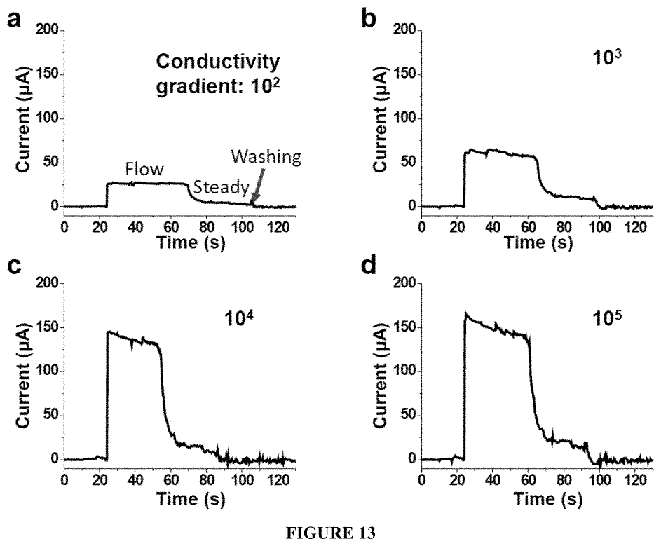

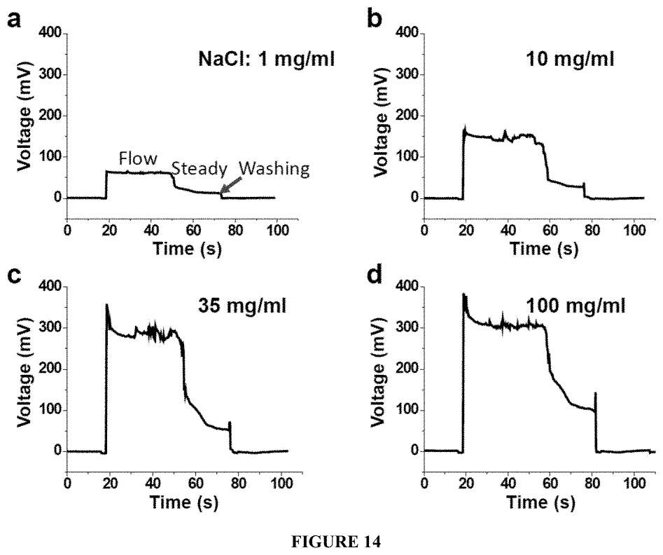

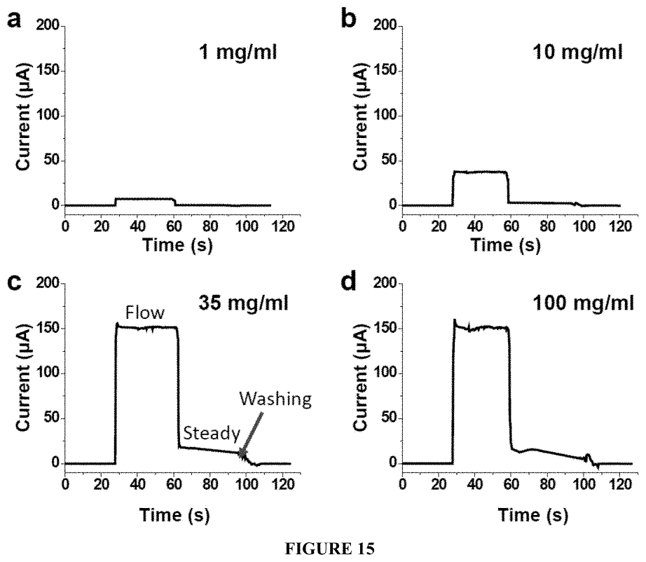

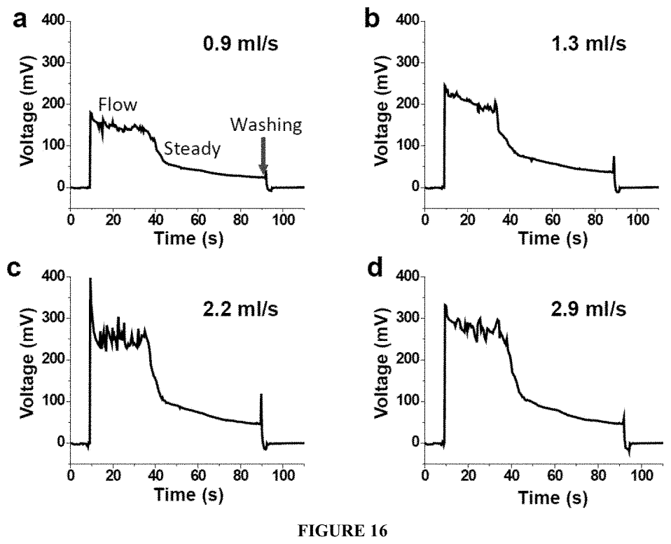

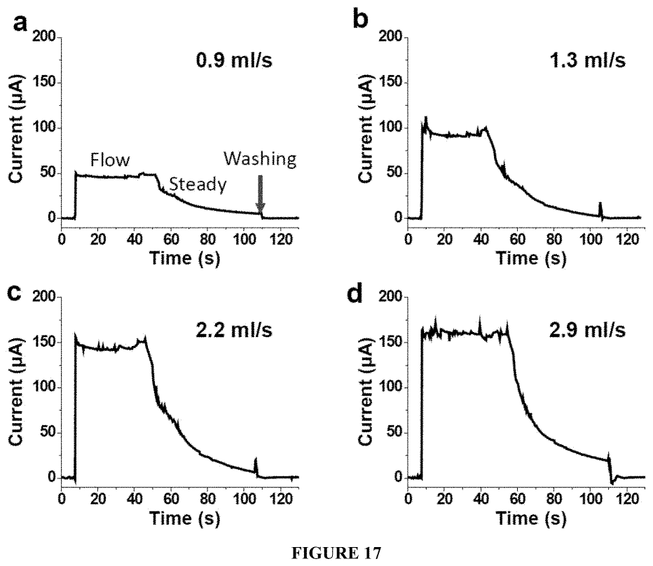

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Disclosed herein are conductive films having a resistance gradient along at least a segment of the film. Generally, such films have a portion of highest electrical resistance and a portion of lowest electrical resistance. The electrical resistance increases along the length of the film moving from the portion of low electrical resistance to the portion of high electrical resistance. In some instance, the portion of highest electrical resistance is proximate to one of the edges of the film, and the portion of lowest electrical resistance is proximate to the edge opposite the edge having the highest resistance. In some instances, the portion of highest electrical resistance is spaced between two edges, and the portion of lowest electrical resistances is proximate to those edges. In other embodiments, the portion of lowest electrical resistance is spaced between two edges, and the portion of highest electrical resistances is proximate to those edges. Films can have a variety of shapes, including circular, oblong, quadrilateral, and others. Suitable quadrilateral films include square and rectangles. In some instances, the portion of highest electrical resistance will extend along an entire edge of the film, the portion of lowest electrical resistance will extend along the entire edge opposite.

The thickness of the films can be no greater than 50 μm, no greater than 25 μm, no greater than 15 μm, no greater than 10 μm, no greater than 5 μm, no greater than 2.5 μm, no greater than 1 μm, no greater than 0.5 μm, no greater than 0.25 μm, or no greater than 0.1 μm.

The portion of highest electrical resistance can have a resistance that is at least 2×, at least 3×, at least 4×, at least 5×, at least 6×, at least 7×, at least 8×, at least 9×, or at least 10× the electrical resistance of the portion of lowest electrical resistance. In some embodiments, the portion of highest electrical resistance can have an electrical resistance from about 100 kΩ to about 50,000 kΩ, from about 100 kΩ to about 25,000 kΩ, from about 500 kΩ to about 25,000 kΩ, from about 1,000 kΩ to about 25,000 kΩ, from about 2,500 kΩ to about 25,000 kΩ, from about 5,000 kΩ to about 25,000 kΩ, from about 10,000 kΩ to about 25,000 kΩ, or from about 15,000 kΩ to about 20,000 kΩ. The portion of highest electrical resistance can have an electrical resistance from about 0.5 kΩ to about 100 kΩ, from about 0.5 kΩ to about 75 kΩ, from about 1 kΩ to about 75 kΩ, from about 1 kΩ to about 50 kΩ, from about 1 kΩ to about 25 kΩ, from about 1 kΩ to about 20 kΩ, from about 1 kΩ to about 10 kΩ, or from about 1 kΩ to about 5 kΩ.

The conductive films disclosed herein can include an electrically conductive polymer, for instance a poly(thiophene), poly(aniline), poly(pyrrole), poly(carbozole), poly(azepine), or polyphenylene sulfide polymer. Exemplary polythiophenes include poly(3,4-propylenedioxythiophene) and poly(3,4-ethylenedioxythiophene). In certain embodiments, the conductive polymer can have the formula:

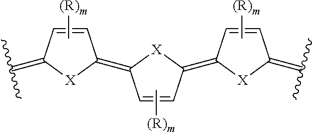

wherein X is NH, S, O, or Se, R is C₁₋₆ alkyl, C₁₋₆ alkoxy, C₁₋₆ haloalkyl, C₁₋₆ haloalkoxy, F, Cl, Br, I, CN, NO₂, and m is 0, 1 or 2. In some embodiments, two R groups may be together form a ring, such as found in poly(3,4-ethylenedioxythiophene). Compounds in which X is NH are designated polypyrroles, when X is O are designated polyfuran, when X is S are designated polythiophene, and when X is Se are designated polyseleophene. In some embodiments, the conductive polymer can include compounds in which X is a mixture of O, S and/or NH.

The conductive polymers may be doped by a primary dopant, as well as by one or more secondary dopants. The primary dopant can be polymeric, for instance a polysulfonic or polycarboxylic acid. Polystyrene sulfonate is one such suitable polymeric dopant. Suitable secondary dopants include transition metal salts, for instance InCl₃, CuCl₂, BiNO₃, ZnCl₂, CdCl₂, PbCl₂, PdCl₂, SbCl₃, and CoCl₃. In some instances, two or more secondary dopants may be employed.

Conductive films including a conductive polymer, polymeric dopant, and optional secondary dopants may be prepared according to conventional techniques.

Graduated electrical resistances may be imparted to the conductive films using electrochemical oxidation. The electrochemical oxidation may be carried out by submerging a conductive film (as described above) in an electrolyte solution. Suitable electrolyte solutions include aqueous solutions of BiNO₃, InCl₃, CuCl₂, FeCl₃ and NaCl. The electrolyte solution may have a concentration from 0.001-1 M, from 0.005-0.5 M, from 0.001-0.25 M, from 0.001-0.1 M, or from 0.05-0.1 M. The pH of the electrolyte solution can be less than 7, less than 6, less than 5, less than 4, less than 3, less than less than 2, or less than 1. The pH of the electrolyte solution may be adjusted using the mineral acid counterpart of the electrolyte salt. For instance, for aqueous solution of BiNO₃, the pH may be adjusted using nitric acid.

Positive and negative electrodes are in contact with the electrolyte solution. An electrical potential between the two electrodes oxidizes the conductive polymer, thereby increasing its electrical resistance. The graduated electrical resistance is controlled by the shape of the electrodes, as well as the spatial distance of each electrode from the film.

For instance, in some embodiments, the film can define a plane, and the location of the positive and negative electrodes can be defined in relation to that plane. As used herein, the term distance from the film refers to the length along the plane the electrode is from the edge of the film. As used herein, the term height from the film refers the distance the electrode is above or below the plane of the film. An electrode directly above (2 cm) the edge of the film can be said to have a height of 2 cm and a distance of 0. In some instances, the positive electrode may have a distance from the film of 0-10 cm, 0-5 cm, 0-2.5 cm, 0-2 cm, 0-1.5 cm, 0-1 cm, 0-0.5 cm, 1-10 cm, 1-5 cm, 1-2.5 cm, 1-2 cm, 2.5-10 cm, or 5.0-10 cm. In some instances, the negative electrode may have a distance from the film of 0-10 cm, 0-5 cm, 0-2.5 cm, 0-2 cm, 0-1.5 cm, 0-1 cm, 0-0.5 cm, 1-10 cm, 1-5 cm, 1-2.5 cm, 1-2 cm, 2.5-10 cm, or 5.0-10 cm. The positive electrode may have a height from the film of 0-5 cm, 0-4 cm, 0-3 cm, 0-2 cm, 0-1 cm, 0-0.5 cm, 0.5-5 cm, 1.0-5 cm, or 2.5-5 cm. The negative electrode may have a height from the film of 0-5 cm, 0-4 cm, 0-3 cm, 0-2 cm, 0-1 cm, 0-0.5 cm, 0.5-5 cm, 1.0-5 cm, or 2.5-5 cm. In some instances, the negative electrode may have a negative height, meaning it is on the opposite side of the film from the positive electrode.

The positive electrode may be a rod having a length of at least 0.5 mm, at least 1 mm, at least 2 mm, at least 3 mm, at least 4 mm, at least 5 mm, at least 6 mm, at least 7 mm, at least 8 mm, at least 9 mm, or at least 10 mm. When a one-dimensional gradient is desired, it is preferred that the diameter of the rod be greater than the width of the film. When a two-dimensional gradient is desired, it is preferred that the diameter of the rod be less than the width of the polymer. As used herein, the term length refers to the portion of electrode that is submerged in the electrolyte. Similarly, the negative electrode may be a rod having a length of at least 0.5 mm, at least 1 mm, at least 2 mm, at least 3 mm, at least 4 mm, at least 5 mm, at least 6 mm, at least 7 mm, at least 8 mm, at least 9 mm, or at least 10 mm. The positive electrode may be an annulus, in which the distance between the inner and outer circumferences is at least 0.5 mm, at least 1 mm, at least 2 mm, at least 3 mm, at least 4 mm, at least 5 mm, at least 6 mm, at least 7 mm, at least 8 mm, at least 9 mm, or at least 10 mm. The negative electrode may be an annulus, in which the distance between the inner and outer circumferences is at least 0.5 mm, at least 1 mm, at least 2 mm, at least 3 mm, at least 4 mm, at least 5 mm, at least 6 mm, at least 7 mm, at least 8 mm, at least 9 mm, or at least 10 mm.

In some instances, the positive electrode can disposed co-planar to and parallel with the edges of the film. The length of the positive electrode can be equal to the length of the edge of the film. In some instances, the negative electrode can disposed co-planar to and parallel with the edges of the film. The length of the positive electrode can be equal to the length of the edge of the film. In some instances, the positive electrode can be a ring, e.g. an annulus, which is coplanar and surrounds the film, while the negative electrode is disposed above and in the centre of the ring. In other embodiments, the negative electrode is the annulus surrounding the film, while the positive electrode is disposed above and in the centre of the annulus.

The electrochemical oxidation can be conducted for a period of from 1-60 minutes, from 1-45 minutes, from 1-30 minutes, from 1-15 minutes, from 1-10 minutes, from 1-5 minutes, from 5-60 minutes, from 5-45 minutes, from 5-30 minutes, from 5-15 minutes, from 5-10 minutes, from 10-60 minutes, from 10-45 minutes, or from 10-30 minutes.

In some embodiments, the electrical potential may be created by applying a constant current across the electrodes. The current can be from 0.1-100 mA, from 0.1-50 mA, from 0.5-50 mA, from 0.1-25 mA, from 0.1-10 mA, from 0.1-5 mA, from 0.5-5 mA, from 1-10 mA, from 5-10 mA, from 10-50 mA, or from 10-25 mA. In some embodiments, the electrical potential may be created by applying a constant voltage across the electrodes. The constant applied voltage can be from 0.1-10 V, from 0.5-10 V, from 1-10 V, from 0.1-5 V, from 0.1-2.5 V, from 0.5-2.5 V, or from 1-2.5 V.

The films disclosed herein exhibit high stability of the conductive gradient over time. For instance, the following table illustrates electrical resistances along a film measured after the film was prepared, and then again approximately five months later:

| | | (film conductivity) |
|---|---|---|
| (resistance) | | Unit S/m |
| 87 | MΩ | 4.6 × 10⁻¹ |
| 12 | MΩ | 3.3 |
| 450 | kΩ | 90 |
| 107 | kΩ | 3.7 × 10² |
| 40 | kΩ | 1.0 × 10³ |
| 21 | kΩ | 1.9 × 10³ |
| 15 | kΩ | 2.7 × 10³ |
| 7.4 | kΩ | 5.4 × 10³ |
| 2.4 | kΩ | 1.6 × 10⁴ |
| 102 ± 10 | MΩ | 3.9 ± 0.5 × 10⁻¹ |
| 15 ± 3 | MΩ | 2.6 ± 0.4 |
| 550 ± 50 | kΩ | 72 ± 6 |
| 130 ± 30 | kΩ | 3.0 ± 0.5 × 10² |
| 45 ± 8 | kΩ | 0.9 ± 0.2 × 10³ |
| 30 ± 5 | kΩ | 1.3 ± 0.2 × 10³ |
| 13 ± 3 | kΩ | 3.0 ± 0.5 × 10³ |
| 8.2 ± 1.2 | kΩ | 4.8 ± 0.6 × 10³ |
| 3.2 ± 0.6 | kΩ | 1.2 ± 0.2 × 10⁴ |

Due to the conductivity gradient, a voltage/current can be generated on the film by passing an electrolyte across the film. The electrical energy thus obtained can then be stored in a battery or other load. In some embodiments, a channel is formed using the gradient film, in which one end of the channel features the portion of highest electrical resistance. This portion may be designated the high electrical resistance end (“HERE”). The other end features the portion of lowest electrical resistance, and may be designated the low electrical resistance end (“LERE”). An electrolyte solution is passed from one end of the channel to the other, thereby generating a voltage between the two ends. Each of the ends is fitted with a terminal which is in electrical communication with a load capable of storing the generated electrical energy. Suitable loads include capacitors and batteries. A preferred electrolyte is ocean water.

In certain embodiments, a voltage-generating channel is provided, in which the channel includes a first end and a second end, with an interior surface extending between the two ends. The graduated films disclosed herein can be disposed on at least a portion of the surface. The first portion of the film can define a first pole, which is in electrical communication with a first electrode. The second portion of the film defines a second pole, which is in electrical communication with a second electrode. Generated electricity can be accumulated in a suitable energy storage device, which would feature a first and second terminal. Suitable devices include batteries and capacitors. The first electrode can be in electrical communication with a first terminal of an energy storage device and said second electrode in electrical communication with a second terminal of the energy storage device. In some embodiments, a plurality of channels can be provided to deliver energy to a single energy storage device. In such embodiments, the first electrode of each channel can be in electrical communication with the first terminal of the energy storage device, and the second electrode of each channel can in electrical communication with the second terminal of the energy storage device.

The channel can come in a variety of shapes, including closed (i.e., tubes) and open (i.e, troughs). The shape of the channel can be defined according to a cross-section taken perpendicular to the length of the channel. Closed channels have cross sections such as circles, ovals and polygons, whereas open channels have cross sections in the shape of a U or V.

In some embodiments, a plurality of energy harvesters can be arranged to increase the total voltage/current that is created. Essentially, a first channel is provided, with the HERE is electrical communication with a load, and the LERE in electrical communication with the HERE of a second energy harvesting channel. The LERE of the second channel can be in electrical communication with the HERE of a further channel, and any number of subsequent channels can be included in the series. The LERE of the final channel is in electrical communication with the load, thereby completing the circuit.

For embodiments featuring a plurality of channels, it is generally preferred that they are all oriented along the same axis, such that an electrolyte first contacts the some portion of each film.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be

What is claimed is:

1. A film having a first end and a second end, having a non-uniform electrical resistance, the film having a first portion and second portion, wherein the highest electrical resistance is at the first portion and the lowest electrical resistance is at the second portion.

2. The conductive film according to claim 1, wherein the first portion is proximate to the first end, and the second portion is proximate to the second end.

3. The conductive film according to claim 1, wherein the first portion is at a point spaced between the first and second end.

4. The conductive film according to claim 3, wherein the second portion is proximate to the first and second ends.

5. The conductive film according to claim 1, wherein the second portion is at a point spaced between the first and second end.

6. The conductive film according to claim 5, wherein the first portion is proximate to the first and second ends.

7. The conductive film according to claim 1, wherein the first portion has an electrical resistance that is at least 4× the electrical resistance of the second portion.

8. The conductive film according to claim 1, wherein the first portion has an electrical resistance from about 5,000 kΩ to about 25,000 kΩ.

9. The conductive film according to claim 8, wherein the second portion has an electrical resistance from about 0.5 kΩ to about 100 kΩ.

10. The conductive film according to claim 1, wherein the conductive film comprises an asymmetrically oxidized electrically conductive polymer.

11. The conductive film according claim 1, wherein the conductive polymer comprises a polymeric primary dopant.

12. The conductive film according to claim 11, wherein polymeric primary dopant comprises polystyrene sulfonate.

13. The conductive film according to claim 11, wherein the conductive polymer comprises a metal salt secondary dopant.

14. The conductive film according to claim 13, wherein the metal salt secondary dopant comprises a transition metal salt.

15. The conductive film according to claim 14, wherein the transition metal salt comprises InCl₃, CuCl₂, BiNO₃, ZnCl₂, CdCl₂, PbCl₂, PdCl₂, SbCl₃, CoCl₃, or a combination thereof.

16. A method of preparing the conductive film according to claim 1, comprising:
a) providing a conductive film in an electrolyte solution, wherein the electrolyte solution is in electrical communication with a first electrode and second electrode, said first electrode closer in space to said first portion than any other part of the conductive film, said second electrode closer in space to said second portion that any other part of the conductive film;
b) generating an electrical potential between the first and second electrode for a length of time, thereby oxidizing the first portion to a greater extent than the second portion.

17. A voltage-generating channel comprising:
a first end comprising a first electrode a second end comprising a second electrode;
an interior surface extending between the first end and second end, and the graduated film according to claim 1 disposed on at least a portion of the first end and second end;
wherein the first portion of the film defines a first pole in electrical communication with the first electrode; and
the second portion of the film defines a second pole in electrical communication with the second electrode.

18. The voltage-generating channel according to claim 17, wherein said first electrode is in electrical communication with a first terminal of an energy storage device and said second electrode in electrical communication with a second terminal of the energy storage device.

19. The voltage-generating channel according to claim 18, wherein the energy storage device comprises a capacitor or battery.

20. The voltage-generating channel according to claim 17, wherein a cross-sectional perimeter of the channel taken perpendicular to an axis extending between the first and second ends of the channel is open or closed.

21. An energy harvester comprising a plurality of voltage-generating channels according to claim 17, wherein the first electrode of each channel is in electrical communication with a first terminal of an energy storage device, and the second electrode in each channel is in electrical communication with a second terminal of the energy storage device.
